(19) United States
(12) Patent Application Publication
(10) Pub. No.: US 2007/0061284 A1
(43) Pub. Date: Mar. 15, 2007

(54) Mobile communication terminal capable of separately managing an accompanying file and method thereof

(75) Inventor: Soo Jin Kim, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/501,882

(22) Filed: Aug. 10, 2006

(30) Foreign Application Priority Data
Sep. 13, 2005 (KR) 10-2005-0085394

(51) Int. Cl. G06F 17/30

(52) U.S. Cl. 707/1

(57) ABSTRACT

Mobile communication terminal capable of managing separately an accompanying file according to an embodiment of the present invention includes a wireless circuit unit for receiving a message comprising an accompanying file, a display unit for displaying the received message, a memory unit for storing the received message and a controller for classifying an accompanying file and storing the classified accompanying file in the memory unit.

### CROSS-REFERENCE TO RELATED APPLICATIONS

The present application claims priority from Korean Patent Application No. 10-2005-0085394, filed Sep. 13, 2005, the subject matter of which is incorporated herein by reference.

### BACKGROUND

1. Field of the Invention

The present invention relates to a mobile communication terminal which manages a received message and a method thereof.

2. Description of the Related Art

A mobile communication terminal that allows a user to take photographs, that is, a camera phone has experienced widespread use. Also, as the mobile communication terminal's memory capacity has increased, the mobile communication terminal has become able to store several tens to hundreds pictures or message files which were received through SMS (short message service) or MMS (multimedia message service).

MMS is a type of message service which allows the transmission and reception of multimedia data such as a graphic, a picture, a moving picture or a sound as well as a character. MMS is a next generation messaging service that is a technological improvement over SMS.

The mobile communication terminal having a large capacity of a memory, the ability to transmit a large amount of data fast and a digital camera, can store many files by receiving a moving picture with a message from an outside source as well as store only a character message, a picture or a sound.

However, when a message and an accompanying file were received by the mobile communication terminal, the mobile communication terminals had stored the received message and accompanying file collectively in a single file given their collective storage. Thus, it was difficult to manage the individual media files.

Conventionally, the same type of media files whose the acquisition methods are different from one another were stored in different storage files. Thus, when searching the same type of media files, there was a problem in that a user had to search the media files through different routes.

### SUMMARY

According to an aspect, there is provided a mobile communication terminal, comprising a wireless circuit unit for receiving a message comprising an accompanying file, a display unit for displaying the received message, a memory unit for storing the received message and a controller for classifying an accompanying file according to the type of accompanying file and storing the classified accompanying file in the memory unit.

The controller may control the separate storage or the separate display of the accompanying file and a message comprising the accompanying file.

The controller may classify the accompanying file into one of a character file, an image file, a moving picture file or a sound file on the basis of an extension name of the accompanying file and controls for the accompanying file to separately be stored.

The mobile communication terminal may further comprise an accompanying file analyzing unit for analyzing the extension name of the accompanying file and for providing the analyzed extension name to controller.

The controller may classify the accompanying file according to an extension name of the accompanying file.

When the message comprises a plurality of accompanying files, the controller may classify and store the plurality of accompanying files respectively on the basis of an extension name of the accompanying file.

The message may comprise either an e-mail message or a multimedia message.

According to another aspect, a mobile communication terminal comprises a wireless circuit unit for receiving a message comprising an accompanying file; a display unit for displaying the received message; a memory unit for storing the received message; and a controller for classifying an accompanying file according to a point in time the message was received and storing the classified accompanying file in the memory unit.

According to another aspect, a mobile communication terminal comprises a wireless circuit unit for receiving a message comprising an accompanying file; a display unit for displaying the received message; a memory unit for storing the received message; and a controller for classifying an accompanying file according to information about sender of the message and storing the classified accompanying file in the memory unit.

According to an aspect, there is a method of classifying and managing of an accompanying file, comprising the steps of receiving a message comprising an accompanying file, analyzing by a controller to determine a type of the accompanying file and classifying the accompanying file according to the type of the accompanying file, and storing the classified accompanying file separately.

The method of classifying and managing of an accompanying file may further comprise the step of displaying the classified accompanying file separately.

The accompanying file and a message comprising the accompanying file may be stored separately or displayed separately

The accompanying file may be classified into one of a character file, a picture file, a moving picture file or a sound file on the basis of an extension name of the accompanying file.

The accompanying file may be classified according to an extension name of the accompanying file.

The message may comprise either an e-mail message or a multimedia message.

According to another aspect, there is a method of classifying and managing of an accompanying file, comprising receiving a message comprising an accompanying file; analyzing by a controller to determine a point in time the message was received and classifying the accompanying file according to the time the message was received; and storing the classified accompanying file separately.

According to another aspect, the mobile communication terminal may comprise a wireless circuit unit for receiving a message comprising an accompanying file, a memory unit for storing the accompanying file, a display unit for displaying a list of accompanying files and an execution picture of an accompanying file selected from the list of accompanying files and a controller for classifying the accompanying file into one of a plurality of media files and for controlling the output of a list of media files comprising the accompanying file to the display unit.

The controller may control the separate storage or the separate display of the accompanying file and a message comprising the accompanying file.

The controller may classify the accompanying file into one of a character file, a picture file, a moving picture file or a sound file on the basis of an extension name of the accompanying file.

The mobile communication terminal may further comprise an accompanying file analyzing unit for analyzing the extension name of the accompanying file and for providing the analyzed extension name to the controller.

### BRIEF DESCRIPTION OF THE DRAWINGS

The above aspects of the present invention will be more apparent by describing certain exemplary embodiments of the present invention with reference to the accompanying drawings, in which:

FIG. 1 is a block diagram of a mobile communication terminal which is capable of separately managing an accompanying file according to an embodiment of the present invention,

FIG. 2 is a flow chart providing an explanation of a method for separately managing an accompanying file according to an embodiment of the present invention,

FIG. 3 illustrates a diagram to explain FIG. 2 in more detail,

FIG. 4 is a flow chart providing an explanation of a method for separately managing an accompanying file according to another embodiment of the present invention, and

FIG. 5 illustrates a diagram to explain FIG. 4 in more detail.

### DETAILED DESCRIPTION

Exemplary embodiments of the present invention will be described herein below with reference to the accompanying drawings.

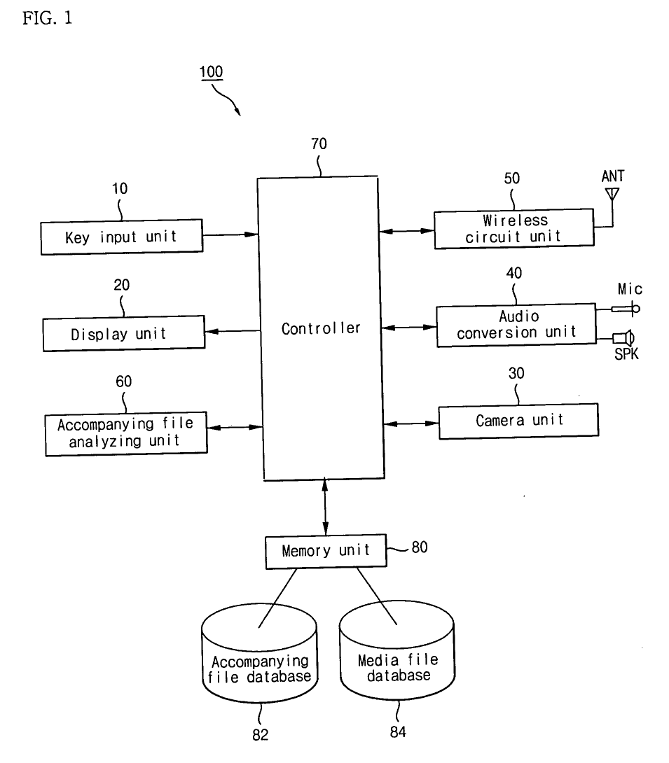

FIG. 1 is a block diagram of a mobile terminal communication terminal which is capable of separately managing an accompanying file according to an embodiment of the present invention

Referring to FIG. 1, mobile communication terminal 100 comprises a key input unit 10, a display unit 20, a camera unit 30, an audio converting unit 40, a wireless circuit unit 50, an accompanying file analyzing unit 60, a controller 70 and a memory unit 80.

The key input unit 10 comprises number key buttons (0-9), special key buttons (*, #, . . . ), character key buttons and function key buttons and performs an interface function which transmits a user's instruction to the controller 70.

The display unit 20 comprises a liquid crystal display or an organic light emitting diode and displays a menu picture selected by a user, an execution picture, a result picture corresponding to the menu picture. In particular, in an embodiment of the present invention, a display unit 20 displays a received accompanying file along with other media files of the same type on a menu picture.

The camera unit 30 photographs a subject and provides files such as a picture or a movie to the controller 70. The camera unit 30 may be mounted in the mobile communication terminal 100 or in the exterior of the mobile communication terminal 100 removably.

The audio conversion unit 40 modulates an audio signal input through a microphone into a wireless signal and demodulates a wireless signal received through the wireless circuit unit 50 into an audio signal. Also, the audio conversion unit 40 converts an audio signal input through a microphone into a sound file.

The wireless circuit unit 50 receives various types of data through an antenna, provides the received data to the controller 70 and transmits data stored in the memory unit 80 to the outside. A wireless circuit unit 50 controls the transmission and the reception of the media file using a short message service and a multimedia message service.

The accompanying file analyzing unit 60 analyzes an extension of an accompanying file and provides the analyzed file extension to the controller 70, when the received message comprises an accompanying file.

The controller 70 controls a mobile communication terminal 100. In particular, the controller 70 separates an accompanying file from the received message and classifies the accompanying file on the basis of an extension name of the accompanying file which is provided from the accompanying file analyzing unit 60 and separately stores the classified accompanying file in the media file database 84 of the memory unit 80.

The controller 70 may separate the accompanying file from a message for multimedia message service received through the wireless circuit unit 50 and collectively store the separated accompanying file in the accompanying file database 82 of the memory unit 80 without regard to the extension name of the accompanying file.

The controller 70 may separately store files, for example, a picture file or a moving picture file which is photographed by the camera unit 30, a character file input through the key input unit 10, a sound file which is obtained through the audio conversion unit 40, on the basis of the extension name in the media file database 84.

The memory unit 80 may comprise a flash memory, random access memory (RAM), electrically erasable programmable read only memory (EEPROM). A basic real time operating system and software for a call processing are stored in the flash memory, and are operated using variable and status data read-out from the RAM. In this case, ROM may be EEPROM, a memory storage type which may be erased and restored electrically and performs input/ouput of the non-volatile data by a command of controller 70.

The memory unit 80 comprises an accompanying file database 82 which stores a received accompanying file collectively and a media file database 84 which separately stores the accompanying file classified on the basis of the extension name of the accompanying file.

For example, the media file database 84 of the memory unit 80 stores the accompanying file of the received multimedia message and a media file such as a character file, a picture file, a moving picture file and a sound file which are obtained respectively by the key input unit 10, the camera unit 30 and the audio conversion unit 40.

The media file database 84 may store an accompanying file which is classified as one of a character file, a picture file, a moving picture file or a sound file. These media files may be files attached in the multimedia message or files obtained the key input unit 10, the camera unit 30 or the audio conversion unit 40.

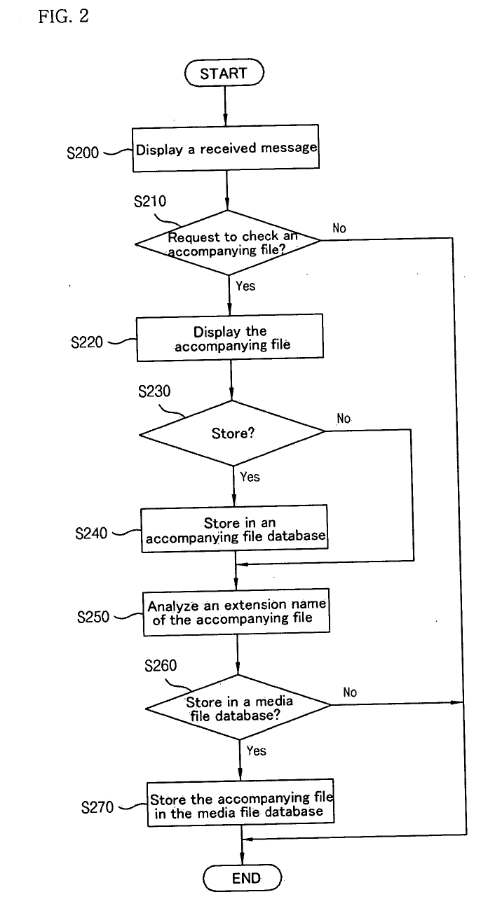

FIG. 2 is a flow chart providing an explanation of a method for separately managing an accompanying file according to an embodiment of the present invention,

Referring to FIG. 1 and FIG. 2, when the mobile communication terminal 100 receives a message through the wireless circuit unit 50, the controller 70 checks the received message and controls the display of such message to a user (S200).

Next, when the user requests to display the accompanying file through the key input unit 10 (S210), since the received message comprises the accompanying file, the controller 70 controls the display unit 20 to display the accompanying file (S220).

Next, the controller 70 determines whether the accompanying file has been stored or not (S230). When the user selects the storage of the accompanying file through the key input unit 10 (S230: Y), the controller 70 stores the selected accompanying file in the accompanying file database 82 (S240).

Next, the accompanying file analyzing unit 60 analyzes the extension name of the accompanying file which is comprised in the received message and provides the analyzed extension name to the controller 70 (S250).

Then, the controller 70 classifies the accompanying file into one of a character file, a picture file, a sound file, a moving picture file on the basis of the analyzed extension name and determines whether to store the accompanying file in a file storage of the media file database 84 (S260).

That is, when a user requests for storing the accompanying file in the file storage of the media file database 84, the controller 70 controls the classified accompanying file to be stored in the file storage of the media file database 84 (S270). The file storage in the media file database 84 comprises various file storages such as a character file storage, a picture file storage, a moving picture file storage and a sound file storage.

That is, the controller 70 controls to store files respectively whose extension name is doc, txt, rtf or hwp in the character file storage, whose extension name is jpg, gif, bmp in the picture file storage, whose extension name is avi, mpg, wmv, mov in the moving picture file storage, and whose extension name is mp3, ogg, wav, mid in the sound file storage.

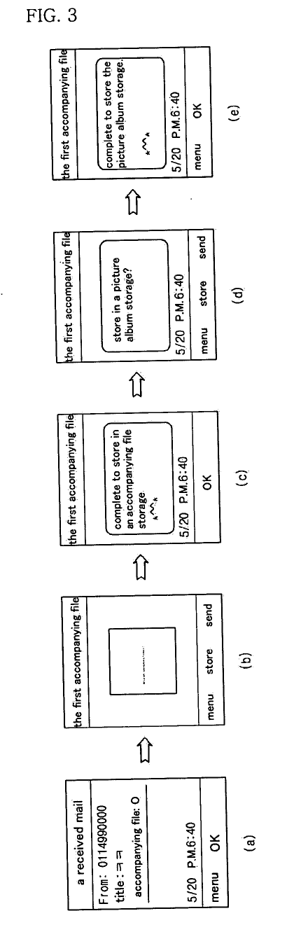

FIG. 3 illustrates a diagram to explain FIG. 2 in more detail. In FIG. 3, the accompanying file comprised in the received message assumes the picture file for the sake of convenience of description.

Referring to FIG. 3, the received message, displayed on the screen, comprises the accompanying file in a step (a). Then, an attached picture file is displayed in a step (b). If a user requests for storing the accompanying file, the accompanying file is stored collectively in the accompanying file database 82 without regard to the kind of files in a step (c).

Then, the extension name is detected by analyzing the accompanying file and a file group which is involved in the extension name is determined. If the accompanying file is a picture file, it is determined whether to store the picture file in the picture file storage of the media file database 84 in a step (d)

Next, when a user demands that the accompanying file be stored in a picture file storage compartment in the media file database 84, the picture file is stored in the picture file storage in the media file database 84 as shown in a step (e).

In this manner, the picture file which is comprised in the received message can be stored in the accompanying file database and in the media file database.

Media files, for example a character file, a moving picture file, a sound file such as a bell sound or a music may be stored in the media file database 84 as media files are classified according to an extension name.

Unlike to the embodiment shown in FIG. 3, when receiving a message including an accompanying file by the wireless circuit unit 50, the accompanying file analyzing unit 30 may analyze an extension name of the accompanying file, and the controller 70 classifies the accompanying file into one of a character file, a picture file, a moving file, a sound file and so forth on the basis of the extension name of the accompanying file and controls the classified file to be stored in the media file database 84.

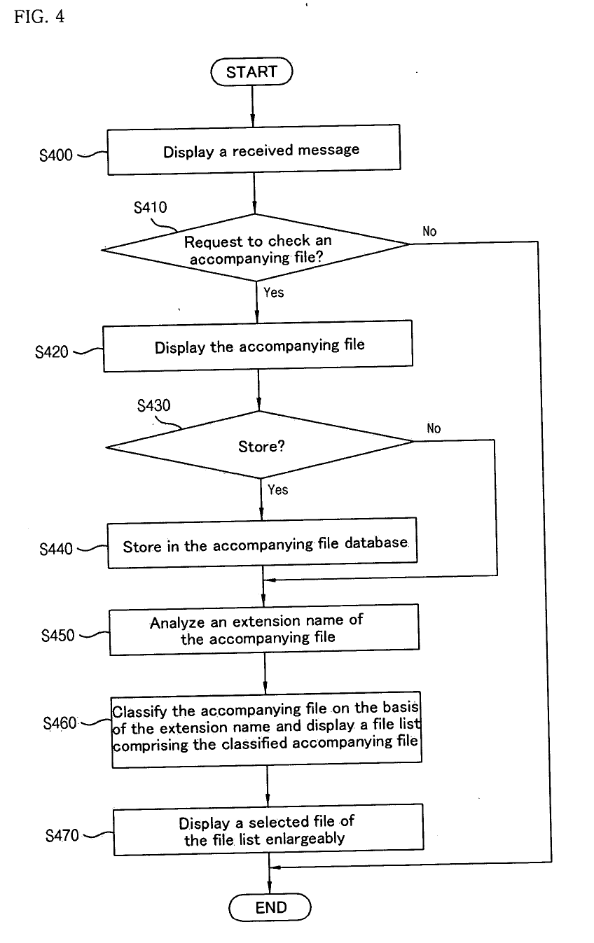

FIG. 4 is a flow chart providing an explanation of a method for separately managing an accompanying file according to another embodiment of the present invention. In FIG. 4, step S400 through step S440 corresponds to step 200 through step S240 in FIG. 2. Thus, a detail explanation for step S400 through step S440 will be omitted.

In step S450, the accompanying file analyzing unit 60 analyzes an extension name of the accompanying file and provides an analyzed extension name to the controller 70 (S450).

Next, the controller 70 classifies the accompanying file into several file groups on the basis of the extension name of the accompanying file which is provided from the accompanying file analyzing unit 60. Then, the controller 70 reads out a list of the file group comprising the classified accompanying file from the accompanying file database 82 and controls the display unit 20 to display the list on screen (S460). File groups can be classified as a character file group, a picture file group, a moving file group or a sound file group and so forth.

Then, when a user selects a file from a file list which is displayed on screen, the controller 70 executes the selected file (S470). That is, when the selected file is a character file, a moving file or a picture file, the controller 70 controls the display unit 20 to display the selected character, moving picture or picture on screen. When the selected file is the sound file, the controller 70 controls the audio conversion unit 40 to output a voice or a music stored in the sound file through a speaker.

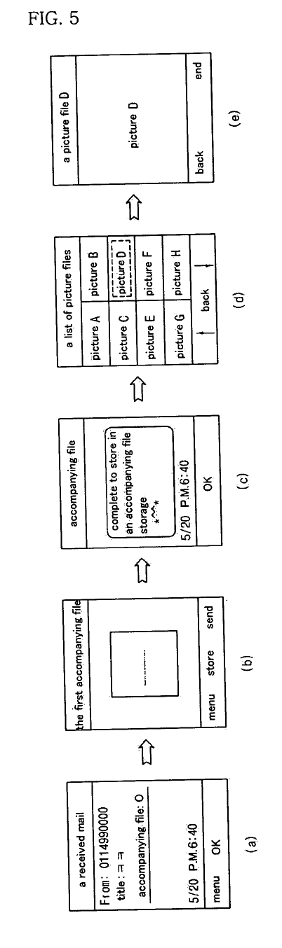

FIG. 5 illustrates a diagram to explain FIG. 4 in more detail. In FIG. 5, the accompanying file which is comprised in the received message is a picture file.

Referring to FIG. 5, like the FIG. 3, the received message, displayed on the screen, comprises the accompanying file in a step (a), then, an attached picture file is displayed in a step (b), and if a user requests for storing the accompanying file, the accompanying file is stored collectively in the accompanying file database 82 without regard to the kind of files in a step (c).

Next, the accompanying file analyzing unit 60 analyzes an extension name of the accompanying file stored in the accompanying file database 82 and provides an analyzed result to the controller 70. The controller 70 classifies the accompanying file on the basis of an extension name of the accompanying file and controls for a list of file groups including the classified file to be displayed. As shown in a step (d) of FIG. 5, because the accompanying file is a picture file, a list of picture files in the accompanying file database 82 is displayed.

When a user selects a predetermined picture file from a list of the displayed picture, the selected picture file is displayed in an enlarged format as shown in a step (e) of FIG. 5.

In an embodiment of the present invention, the accompanying file assumes the picture file, however the present invention applies in a similar manner for media files such as a character, a moving picture, or a sound like a ringing, a music, a voice

Also, an embodiment of the present invention discloses a multimedia message comprising the accompanying file. However, the present invention equally applies to e-mail comprising the accompanying file.

Also, an embodiment of the present invention discloses that the accompanying file is classified on the basis of the extension name. However, the accompanying file can also be classified according to a point in time the message is received or by information about the sender of the message.

When the accompanying file is classified according to a point in time that the message is received, accompanying file can be classified according to a unit of an hour, a day, a day of the week, or a month. Also, When the message arrives at a predetermined time from a point in time of receiving the message, the accompanying file is deleted automatically to use the memory effectively.

When the accompanying file is classified according to information about the sender of the message, when the sender of the message corresponds to a member of the preset group, the accompanying file is classified as corresponding to the group.

According to the above embodiment of the present invention, the received accompanying file is classified, stored and displayed according to a media type. Thus, a user can search easily the same type of a media file.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A mobile communication terminal, comprising:
A wireless circuit unit for receiving a message comprising an accompanying file;
A display unit for displaying the received message;
A memory unit for storing the received message; and
A controller for classifying an accompanying file according to the type of accompanying file and storing the classified accompanying file in the memory unit.

2. The mobile communication terminal of claim 1, wherein the controller controls the separate storage or the separate display of the accompanying file and a message comprising the accompanying file.

3. The mobile communication terminal of claim 1, wherein the controller classifies the accompanying file into one of a character file, an image file, a moving picture file or a sound file on the basis of an extension name of the accompanying file and controls for the accompanying file to separately be stored.

4. The mobile communication terminal of claim 3, further comprising an accompanying file analyzing unit for analyzing the extension name of the accompanying file and for providing the analyzed extension name to controller.

5. The mobile communication terminal of claim 1, wherein the controller classifies the accompanying file according to an extension name of the accompanying file.

6. The mobile communication terminal of claim 1, wherein when the message comprises a plurality of accompanying files, the controller classifies and stores the plurality of accompanying files respectively on the basis of an extension name of the accompanying file.

7. The mobile communication terminal of claim 1, wherein the message comprises either an e-mail message or a multimedia message.

8. The mobile communication terminal of claim 1, wherein the memory unit comprises an accompanying file database for storing the accompanying file collectively and a media file database for storing the classified accompanying file separately.

9. A mobile communication terminal, comprising:
A wireless circuit unit for receiving a message comprising an accompanying file;
A display unit for displaying the received message;
A memory unit for storing the received message; and
A controller for classifying an accompanying file according to a point in time the message was received and storing the classified accompanying file in the memory unit.

10. The mobile communication terminal of claim 9, wherein the controller deletes the accompanying file when the message arrives at a predetermined time from the point in time of receiving the message.

11. A mobile communication terminal, comprising:
A wireless circuit unit for receiving a message comprising an accompanying file;
A display unit for displaying the received message;
A memory unit for storing the received message; and
A controller for classifying an accompanying file according to information about the sender of the message and storing the classified accompanying file in the memory unit.

12. The mobile communication terminal of claim 11, wherein the controller analyzes the information about the sender of the message, and when the sender corresponds to a member in a preset group, the controller classifies the accompanying file as corresponding to the group.

13. A method of classifying and managing of an accompanying file in a mobile communication terminal, comprising the steps of:
Receiving a message comprising an accompanying file;
Analyzing by a controller to determine a type of the accompanying file and classifying the accompanying file according to the type of the accompanying file; and
Storing the classified accompanying file separately.

14. The method of claim 13, further comprising the step of displaying the classified accompanying file separately.

15. The method of claim 13, wherein the accompanying file and a message comprising the accompanying file are stored separately or displayed separately

16. The method of claim 13, wherein the accompanying file is classified into one of a character file, a picture file, a moving picture file or a sound file on the basis of an extension name of the accompanying file.

17. The method of claim 13, wherein the accompanying file is classified according to an extension name of the accompanying file.

18. The method of claim 13, wherein when the message comprises a plurality of accompanying files, the plurality of accompanying files are classified and stored respectively on the basis of an extension name of the accompanying file.

19. The method of claim 13, wherein the message comprises either an e-mail message or a multimedia message.

20. The method of claim 13, further comprising the steps of storing the accompanying file collectively.

21. A method of classifying and managing of an accompanying file in a mobile communication terminal, comprising the steps of:
Receiving a message comprising an accompanying file;
Analyzing by a controller to determine a point in time the message was received and classifying the accompanying file according to the time of receiving the message; and
Storing the classified accompanying file separately.

22. The method of claim 21, wherein the accompanying file is deleted when it arrives at a predetermined time from the point in time of receiving the message.

23. A method of classifying and managing of an accompanying file in a mobile communication terminal, comprising the steps of:
Receiving a message comprising an accompanying file;
Analyzing by a controller to determine information about the sender of the message and classifying the accompanying file according to the sender of the message; and
Storing the classified accompanying file separately.

24. The method of claim 23, wherein when the sender corresponds to a member in a preset group, the accompanying file is classified as corresponding to the group.

25. The mobile communication terminal, comprising:
A wireless circuit unit for receiving a message comprising an accompanying file;
A memory unit for storing the accompanying file;
A display unit for displaying a list of accompanying files and an execution picture of an accompanying file selected from the list of accompanying files; and
A controller for classifying the accompanying file into one of a plurality of media files and for controlling the output of a list of media files comprising the accompanying file to the display unit.

26. The mobile communication terminal of claim 25, wherein the controller controls the separate storage or the separate display of the accompanying file and a message comprising the accompanying file.

27. The mobile communication terminal of claim 25, wherein the controller classifies the accompanying file into one of a character file, a picture file, a moving picture file or a sound file on the basis of an extension name of the accompanying file.

28. The mobile communication terminal of claim 27, further comprising an accompanying file analyzing unit for analyzing the extension name of the accompanying file and for providing the analyzed extension name to the controller.
